(19) United States
(12) Patent Application Publication
(10) Pub. No.: US 2013/0077056 A1
(43) Pub. Date: Mar. 28, 2013

(54) PROJECTION DISPLAY APPARATUS

(71) Applicant: Sanyo Electric Co., Ltd., Osaka (JP)

(72) Inventor: Michihiro OKUDA, Osaka (JP)

(73) Assignee: SANYO ELECTRIC CO., LTD., Osaka (JP)

(21) Appl. No.: 13/626,310

(22) Filed: Sep. 25, 2012

(30) Foreign Application Priority Data
Sep. 26, 2011 (JP) 2011-209543

(51) Int. Cl. G03B 21/14

(52) U.S. Cl. 353/31

(57) ABSTRACT

A projection display apparatus includes a light source unit having an excitation light source that emits excitation light, a rotating body, a plurality of imagers, and a projection unit. The rotating body has a rotating surface provided with a light emitting body that emits emission light in response to the excitation light. A separation optical element separates main component light with a predetermined wavelength, included in emission light, into a first optical path, and separates remaining component light, other than the main component light, included in the emission light, into a second optical path.

### CROSS REFERENCE TO RELATED APPLICATIONS

This application is based upon and claims the benefit of priority from prior Japanese Patent Application No. 2011-209543, filed on Sep. 26, 2011; the entire contents of which are incorporated herein by reference.

### BACKGROUND OF THE INVENTION

1. Field of the Invention

The present invention relates to a projection display apparatus provided with a light source that emits excitation light and a disk-shaped rotating body that rotates about a rotating shaft.

2. Description of the Related Art

Conventionally, a projection display apparatus has been known that is provided with a light source, an imager that modulates light emitted from the light source, and a projection unit that projects light modulated by the imager on a projection surface.

Here, there has been proposed a projection display apparatus provided with a light emitting body that emits reference image light (hereinafter, referred to as emission light) such as red component light, green component light, and blue component light by using the light emitted from the light source as excitation light (for example, Japanese Unexamined Patent Application Publication No. 2010-085740). Specifically, a plurality of types of light emitting bodies that emit each color component light are provided in a color wheel, and each color component light is emitted in a time division manner together with the rotation of the color wheel.

However, a light emitting body with high light emission efficiency, such as a fluorescent substance, generally has a wide spectrum width in many cases. In other words, color purity of emission light emitted from the light emitting body is low. Accordingly, a color reproduction range reproducible using the emission light is narrowed.

### SUMMARY OF THE INVENTION

A projection display apparatus according to a first feature comprises: a light source unit (light source unit 110) including an excitation light source (light source 10B₁) that emits excitation light, a rotating body (color wheel 20) of disk-shaped that rotates about a rotating shaft, a plurality of imagers (DMDs 40) that modulates a light emitted from the light source unit, and a projection unit (projection unit 50) that projects light modulated by the plurality of imagers. The rotating body includes a rotating surface (rotating surface 21) provided with a light emitting body that emits emission light in response to the excitation light. The light source (light source 10B₂ or light source 10R) unit includes a solid light source that emits predetermined color component light, in addition to the excitation light source. The plurality of imagers include a first imager (DMD 10G) that modulates the emission light and a second imager (DMD 10B or DMD 10R) that modulates the predetermined color component light. A first optical path from the light source unit to the first imager and a second optical path from the light source unit to the second imager have a common optical path common to the first optical path and the second optical path. A separation optical element (prism 220 or prism 230), that separates the predetermined color component light into the second optical path, is provided on the common optical path. The separation optical element separates main component light with a predetermined wavelength, included in the emission light, into the first optical path, and separates remaining component light, other than the main component light, included in the emission light, into the second optical path.

In the first feature, the emission light has green component light as the main component light. The predetermined color component light is red component light or blue component light.

In the first feature, the emission light has green component light as the main component light. The predetermined color component light is red component light or blue component light. A peak wavelength of the blue component light is in a range of 440 nm to 470 nm. A peak wavelength of the main component light of the green component light is in a range of 500 nm to 570 nm. A spectrum width of the main component light of the green component light is 90 nm to 130 nm in full width at half maximum. A peak wavelength of the red component light is in a range of 630 nm to 650 nm.

In the first feature, a light emitting period of the excitation light source is different from a light emitting period of the solid light source.

### BRIEF DESCRIPTION OF THE DRAWINGS

FIG. 1 is a diagram illustrating a projection display apparatus 100 according to a first embodiment.

FIG. 2 is a diagram illustrating a color wheel 20 according to the first embodiment.

FIG. 3 is a diagram illustrating a wavelength range of each color component light according to the first embodiment.

FIG. 4 is a diagram illustrating a color reproduction range according to the first embodiment.

FIG. 5 is a diagram illustrating the superposition of each color component light according to the first embodiment.

FIG. 6 is a diagram illustrating a color wheel 20 according to a first modification.

FIG. 7 is a diagram illustrating the superposition of each color component light according to the first modification.

### DETAILED DESCRIPTION OF THE EMBODIMENTS

Hereinafter, a projection display apparatus according to embodiments of the present invention is described with reference to drawings. In the following drawings, same or similar parts are denoted with same or similar reference numerals.

However, it should be noted that the drawings are merely exemplary and ratios of each dimension differ from the actual ones. Therefore, the specific dimensions, etc., should be determined in consideration of the following explanations. Moreover, it is needless to say that relations and ratios among the respective dimensions differ among the diagrams.

### [Overview of First Embodiment]

A projection display apparatus according to an embodiment comprises: a light source unit including an excitation light source that emits excitation light, a rotating body of disk-shaped that rotates about a rotating shaft, a plurality of imagers that modulates a light emitted from the light source unit, and a projection unit that projects light modulated by the plurality of imagers. The rotating body includes a rotating surface provided with a light emitting body that emits emission light in response to the excitation light. The light source unit includes a solid light source that emits predetermined color component light, in addition to the excitation light source. The plurality of imagers include a first imager that modulates the emission light and a second imager that modulates the predetermined color component light. A first optical path from the light source unit to the first imager and a second optical path from the light source unit to the second imager have a common optical path common to the first optical path and the second optical path. A separation optical element, that separates the predetermined color component light into the second optical path, is provided on the common optical path. The separation optical element separates main component light with a predetermined wavelength, included in the emission light, into the first optical path, and separates remaining component light, other than the main component light, included in the emission light, into the second optical path.

In the embodiment, the separation optical element separates the main component light with a predetermined wavelength, included in the emission light, into the first optical path, and separates the remaining component light, other than the main component light, included in the emission light, into the second optical path. That is, only the main component light of the emission light is guided to the first imager. Meanwhile, in addition to the predetermined color component light emitted from a solid light source, the remaining component light, other than the main component light, included in the emission light, is guided to a second imager.

In this way, since a wavelength range of the emission light (the main component light) guided to the first imager is narrow, even in the case of using a light emitting body, it is possible to expand a color reproduction range. Furthermore, in general, since the color purity of the predetermined color component light emitted from the solid light source is significantly high, and the emission light (the remaining component light other than the main component light) is guided to the second imager in addition to the predetermined color component light, the color reproduction range is an appropriate range.

### First Embodiment

### Projection Display Apparatus

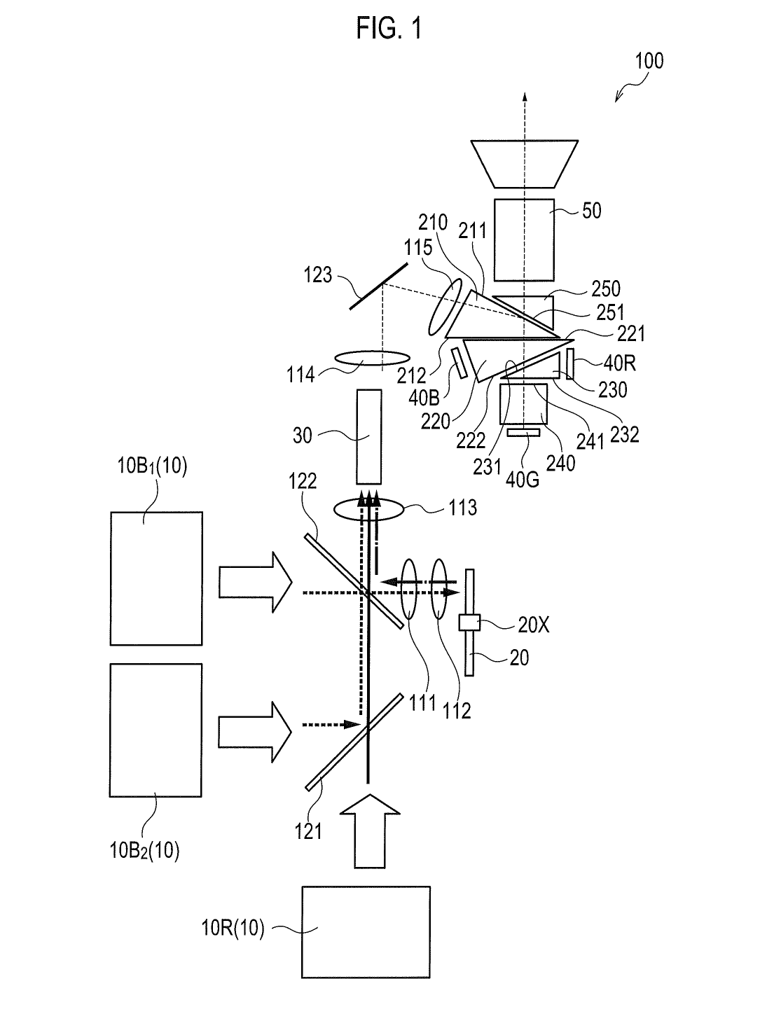

Hereinafter, a projection display apparatus according to a first embodiment is explained. FIG. 1 is a diagram illustrating a projection display apparatus 100 according to the first embodiment. In addition, in the first embodiment, a description will be provided for the case of using red component light R, green component light G, and blue component light B as reference image light.

In the first embodiment, emission light has the green component light G as main component light. A predetermined color component light is the blue component light B and the red component light R.

As illustrated in FIG. 1, firstly, the projection display apparatus 100 includes a light source unit 10, a color wheel 20, a rod integrator 30, a DMD 40, and a projection unit 50.

The light source unit 10, for example, includes a plurality of solid light sources such as LDs (Laser Diodes) or LEDs (Light Emitting Diodes). In the first embodiment, a light source 10B₁, a light source 10B₂, and a light source 10R are provided as the light source unit 10.

The light source 10B₁ is an excitation light source that emits the blue component light B as excitation light. The light source 10B₁, for example, includes LD (Laser Diode) or LED (Light Emitting Diode).

The light source 10B₂ is a solid light source that emits the blue component light B as a reference image light. The light source 10B₂, for example, includes LD (Laser Diode), LED (Light Emitting Diode) and the like.

The light source 10R is a solid light source that emits the red component light R as the reference image light. The light source 10R, for example, includes LD (Laser Diode) or LED (Light Emitting Diode).

The color wheel 20 is that rotates about a rotating shaft 20X that extends along an optical axis of the excitation light (the blue component light B). The color wheel 20 is an example of a reflective rotating body that reflects the excitation light and the emission light.

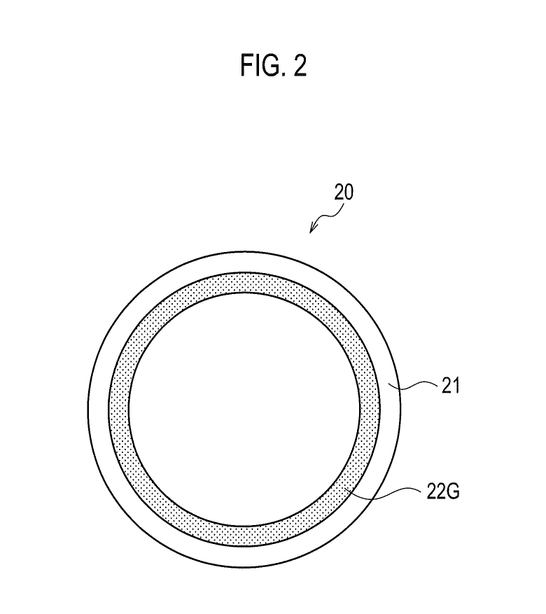

Specifically, as illustrated in FIG. 2, the color wheel 20 includes a rotating surface 21 and a green region 22G. The rotating surface 21 includes a reflective film. The green region 22G has a light emitting body G that emits the green component light G (the emission light) in response to the excitation light (the blue component light B) emitted from the light source 10B₁. The light emitting body G is a fluorescent substance or a phosphorescent body.

The rod integrator 30 is a solid rod including a transparent member such as glass. The rod integrator 30 uniformizes the light emitted from the light source unit 10. In addition, the rod integrator 30 may be a hollow rod in which an inner wall thereof includes a mirror surface.

The DMD 40 modulates the light emitted from the light source unit 10. Specifically, the DMD 40 includes a plurality of micromirrors, wherein the plurality of micromirrors are movable. Each micromirror is basically equivalent to one pixel. The DMD 40 switches whether to reflect a light toward the projection unit 50 by changing an angle of each micromirror.

In the first embodiment, as the DMD 40, a DMD 40R, a DMD 40G, and a DMD 40B are provided. The DMD 40R modulates the red component light R based on a red image signal R. The DMD 40G modulates the green component light G based on a green image signal G. The DMD 40B modulates the blue component light B based on a blue image signal B.

In the first embodiment, the DMD 40G is an example of the first imager, and the DMD 40R and the DMD 40B are an example of the second imager.

The projection unit 50 projects an image light modulated by the DMD 40 on the projection surface.

Secondly, the projection display apparatus 100 has desired lens group and mirror group. As the lens group, a lens 111 to a lens 115 are provided, and as the mirror group, a mirror 121 to a mirror 123 are provided.

The lens 111 and the lens 112 are condenser lenses that collect the excitation light (the blue component light B) on a light emitting surface of the light emitting body (the light emitting body G). The lens 113 is a light collection lens that collects the light beams emitted from the light source 10B₁, the light source 10B₂, and the light source 10R on a light incident surface of the rod integrator 30. The lens 114 and the lens 115 are relay lenses that allow the light emitted from the rod integrator 30 to be formed substantially on the DMD 40 as an image.

The mirror 121 is a dichroic mirror that transmits the red component light R and reflects the blue component light B. The mirror 122 is a dichroic mirror that transmits the blue component light B and the red component light R and reflects the green component light G. The mirror 123 is a reflection mirror that reflects each color component light.

Thirdly, the projection display apparatus 100 has a desired prism group. As the prism group, a prism 210, a prism 220, a prism 230, a prism 240, and a prism 250 are provided.

The prism 210 includes a light transmitting member and has a surface 211 and a surface 212. Since an air gap is provided between the prism 210 (the surface 211) and the prism 250 (a surface 251) and an angle (an incident angle), at which a light incident into the prism 210 is incident into the surface 211, is larger than a total reflection angle, the light incident into the prism 210 is reflected by the surface 211. Meanwhile, since an air gap is provided between the prism 210 (the surface 212) and the prism 220 (a surface 221), but an angle (an incident angle), at which the light reflected by the surface 211 is incident into the surface 212, is smaller than the total reflection angle, the light reflected by the surface 211 passes through the surface 212.

The prism 220 includes a light transmitting member and has a surface 221 and a surface 222. Since an air gap is provided between the prism 210 (the surface 212) and the prism 220 (the surface 221) and an angle (an incident angle), at which blue component light B initially reflected by the surface 222 and blue component light B emitted from the DMD 40B are incident into the surface 211, is larger than the total reflection angle, the blue component light B initially reflected by the surface 222 and the blue component light B emitted from the DMD 40B are reflected by the surface 221. Meanwhile, since an angle (an incident angle), at which the blue component light B reflected by the surface 221 and then reflected by the surface 222 at the second time is incident into the surface 211, is smaller than the total reflection angle, the blue component light B reflected by the surface 221 and then reflected by the surface 222 at the second time passes through the surface 221.

The surface 222 is a dichroic mirror surface that transmits the red component light R and the green component light G, and reflects the blue component light B. Accordingly, among the light beams reflected by the surface 211, the red component light R and the green component light G pass through the surface 222, and the blue component light B is reflected by the surface 222. The blue component light B reflected by the surface 221 is reflected by the surface 222.

The prism 230 includes a light transmitting member and has a surface 231 and a surface 232. Since an air gap is provided between the prism 220 (the surface 222) and the prism 230 (the surface 231) and an angle (an incident angle), at which red component light R reflected by the surface 232 by passing through the surface 231 and red component light R emitted from the DMD 40R are incident into the surface 231 again, is larger than the total reflection angle, the red component light R reflected by the surface 232 by passing through the surface 231 and the red component light R emitted from the DMD, 40R are reflected by the surface 231. Meanwhile, since an angle (an incident angle), at which the red component light R reflected by the surface 232 after being emitted from the DMD 40R and reflected by the surface 231 is incident into the surface 231 again, is smaller than the total reflection angle, the red component light R reflected by the surface 232 after being emitted from the DMD 40R and reflected by the surface 231 passes through the surface 231.

The surface 232 is a dichroic mirror surface that transmits the green component light G, and reflects the red component light R. Accordingly, among the light beams having passed through the surface 231, the green component light G passes through the surface 232, and the red component light R is reflected by the surface 232. The red component light R reflected by the surface 231 is reflected by the surface 232. The green component light G emitted from the DMD 40G passes through the surface 232.

The prism 240 includes a light transmitting member and has a surface 241. The surface 241 transmits the green component light G. In addition, the green component light G incident into the DMD 40G and the green component light G emitted from the DMD 40G pass through the surface 241.

The prism 250 includes a light transmitting member and has a surface 251.

In other words, the blue component light B is reflected by the surface 211 (1), is reflected by the surface 222 (2), is reflected by the surface 221 (3), is reflected by the DMD 40B (4), is reflected by the surface 221 (5), is reflected by the surface 222 (6), and passes through the surface 221 and the surface 251 (7). In this way, the blue component light B is modulated by the DMD 40B and is guided to the projection unit 50.

The red component light R is reflected by the surface 211 (1), is reflected by the surface 232 after passing through the surface 212, the surface 221, the surface 222, and the surface 231 (2), is reflected by the surface 231 (3), is reflected by the DMD 40R (4), is reflected by the surface 231 (5), is reflected by the surface 232 (6), and passes through the surface 231, the surface 232, the surface 221, the surface 212, the surface 211, and the surface 251. In this way, the red component light R is modulated by the DMD 40R and is guided to the projection unit 50.

The green component light G is reflected by the surface 211 (1), is reflected by the DMD 40G after passing through the surface 212, the surface 221, the surface 222, the surface 231, the surface 232, and the surface 241 (2), and passes through the surface 241, the surface 232, the surface 231, the surface 222, the surface 221, the surface 212, the surface 211, and the surface 251. In this way, the green component light G is modulated by the DMD 40G and is guided to the projection unit 50.

In the first embodiment, as described above, the emission light is the green component light G. A predetermined color component light is the blue component light B and the red component light R. The first optical path from the light source unit 10 to the first imager (the DMD 40G) and the second optical path from the light source unit 10 to the second imager (the DMD 40R and the DMD 40B) have a common optical path which is common in use.

Here, the prism 220 separates a combined light including the red component light R and the green component light G from the blue component light B by the surface 222. That is, the prism 220 is provided on the common optical path and constitutes a separation optical element that separates the blue component light B into the second optical path.

The prism 220 separates main component light with a predetermined wavelength, of the green component light G (the emission light), into the first optical path to the DMD 40G, and separates remaining component light, other than the main component light, of the green component light G (the emission light), into the second optical path to the DMD 40B.

Furthermore, the prism 230 separates the red component light R from the green component light G by the surface 232. That is, the prism 230 is provided on the common optical path and constitutes a separation optical element that separates the red component light R into the second optical path to the DMD 40R.

The prism 220 separates the main component light with the predetermined wavelength of the green component light G (the emission light) into the first optical path to the DMD 40G, and separates the remaining component light, other than the main component light, of the green component light G (the emission light) into the second optical path to the DMD 40R.

In other words, in the first embodiment, a cutoff wavelength of the surface 222 of the prism 220 is a wavelength for separating the green component light G (the emission light) into the main component light and the remaining component light at a short wavelength side in a wavelength range of the green component light G (the emission light). A cutoff wavelength of the surface 232 of the prism 230 is a wavelength for separating the green component light G (the emission light) into the main component light and the remaining component light at a long wavelength side in the wavelength range of the green component light G (the emission light).

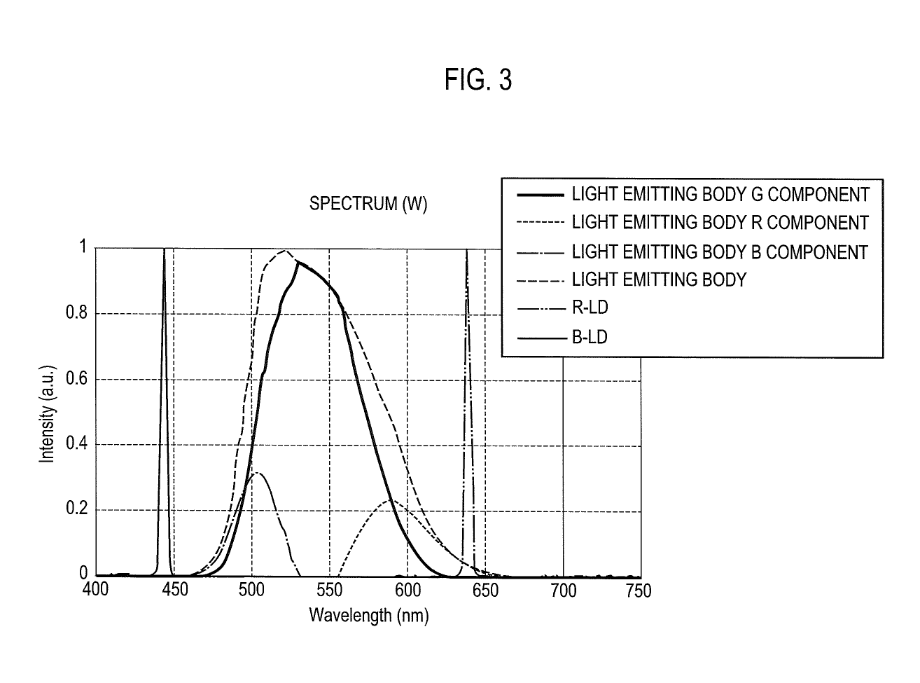

For example, as illustrated in FIG. 3, a peak wavelength of the blue component light B emitted from the light source 10B₂ is in the range of 440 nm to 470 nm (refer to B-LD illustrated in FIG. 3). A peak wavelength of the red component light R emitted from the light source 10R is in the range of 630 nm to 650 nm (refer to B-LD illustrated in FIG. 3).

Here, in the surface 222 of the prism 220, a peak wavelength of the remaining component light separated from the green component light G is about 500 nm (refer to a light emitting body B component illustrated in FIG. 3). Furthermore, in the surface 232 of the prism 230, a peak wavelength of the remaining component light separated from the green component light G is about 570 nm (refer to a light emitting body R component illustrated in FIG. 3). Accordingly, a peak wavelength of the main component light of the green component light G, which is finally guided to the DMD 40G, is in the range of 500 nm to 570 nm (refer to a light emitting body G component illustrated in FIG. 3). In addition, a spectrum width of the main component light of the green component light is 90 nm to 130 nm in full width at half maximum.

Here, as the light emitting body G that emits the light emitting body G component illustrated in FIG. 3, it is possible to use a LAG-based fluorescent substance or a YAG-based fluorescent substance.

In addition, the prism 220 combines the combined light including the red component light R and the green component light G with the blue component light B by the surface 222. The prism 230 combines the red component light R with the green component light G by the surface 232. That is, the prism 220 and the prism 230 serve as a color combining element that combines the color component light beams.

### (Color Reproduction Range)

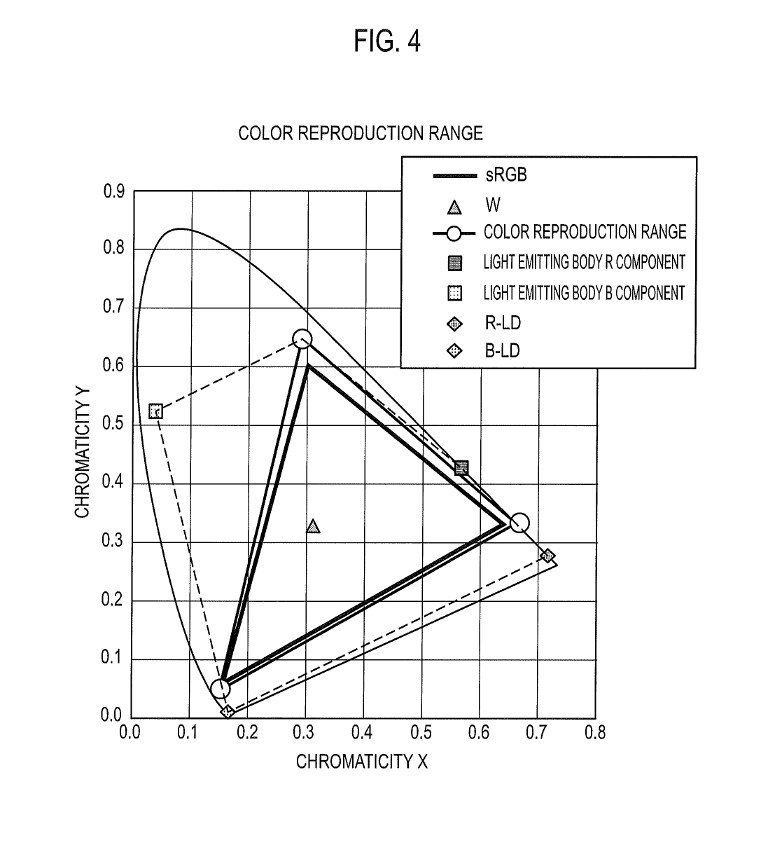

Hereinafter, the color reproduction range according to the first embodiment is explained with reference to FIG. 4. FIG. 4 is a diagram illustrating the color reproduction range according to the first embodiment.

As illustrated in FIG. 4, the purity of the red component light R emitted from the light source 10R is higher than the purity of a red color of a standard color reproduction range (sRGB illustrated in FIG. 4). In the first embodiment, the remaining component light (the light emitting body R component) of the green component light G (the emission light) is superposed on the red component light R emitted from the light source 10R. Accordingly, a red color reproduced by the red component light R is corrected to a yellow color side by the remaining component light of the green component light G (the emission light), so that the color reproduction range is reasonable.

Similarly, the purity of the blue component light B emitted from the light source 10B₂ is higher than the purity of a blue color of the standard color reproduction range (sRGB illustrated in FIG. 4). In the first embodiment, the remaining component light (the light emitting body B component) of the green component light G (the emission light) is superposed on the blue component light B emitted from the light source 10B₂. Accordingly, a blue color reproduced by the blue component light B is corrected to a cyan color side by the remaining component light of the green component light G (the emission light), so that the color reproduction range is reasonable.

Furthermore, since a wavelength range of the green component light G (the emission light) is narrow, the purity of green reproduced by the main component light of the green component light G (the emission light) guided to the DMD 40G is high.

As a consequence, the color reproduction range of the projection display apparatus 100 is expanded, and a color reproduction range wider than the standard color reproduction range (sRGB illustrated in FIG. 4) is achieved.

In addition, the color reproduction range (the color reproduction range indicated by ∘) illustrated in FIG. 4 is a color reproduction range when the light source 10B₁, the light source 10B₂, and the light source 10R are continuously turned on.

### (Superposition of Color Component Light Beams)

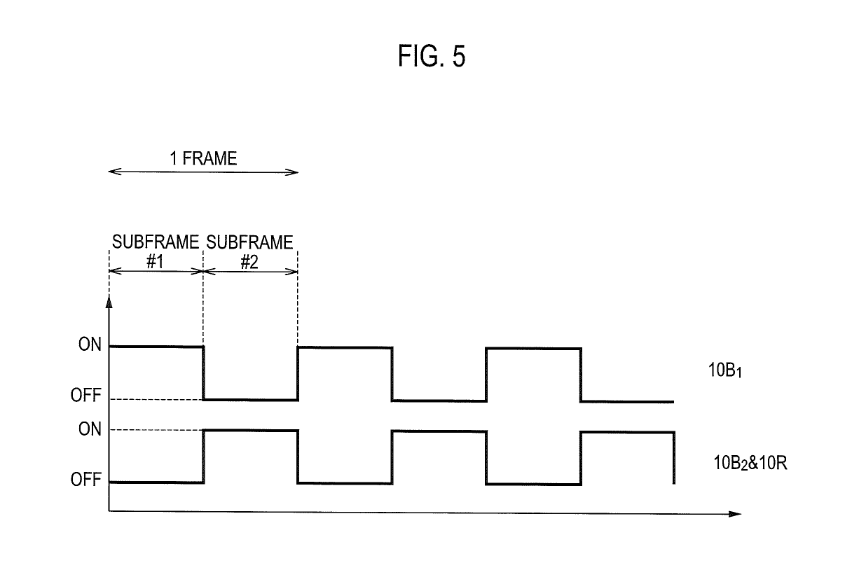

Hereinafter, the superposition of the color component light beams according to the first embodiment is explained with reference to FIG. 5. FIG. 5 is a diagram illustrating the superposition of the color component light beams according to the first embodiment.

As illustrated in FIG. 5, one frame includes two subframes. A subframe #1 is a light emitting period (ON) of the light source 10B₁, and a subframe #2 is a light emitting period (ON) of the light source 10B₂ and the light source 10R. That is, the light emitting period (ON) of the light source 10B₁ is different from the light emitting period (ON) of the light source 10B₂ and the light source 10R.

In addition, in the subframe #1, the main component light of the green component light G (the emission light) is guided to the DMD 40G. Meanwhile, the remaining component light of the green component light G (the emission light) is guided to the DMD 40R and the DMD 40B.

That is, the DMD 40R modulates the remaining component light (the light emitting body R component) of the green component light G (the emission light) in the subframe #1, and modulates the red component light R in the subframe #2. Similarly, the DMD 40B modulates the remaining component light (the light emitting body B component) of the green component light G (the emission light) in the subframe #1, and modulates the blue component light B in the subframe #2.

Meanwhile, the DMD 40G modulates the main component light of the green component light G (the emission light) in the subframe #1. In addition, in the subframe #2, no light is guided to the DMD 40G.

As described above, in the subframe #1, the remaining component light (the light emitting body R component) of the green component light G (the emission light) and the remaining component light (the light emitting body B component) of the green component light G (the emission light) are modulated. Meanwhile, in the subframe #2, the red component light R and the blue component light B are modulated. Accordingly, the light source 10B₁, the light source 10B₂, and the light source 10R are turned on in a time division manner, resulting in the achievement of a color reproduction range (a pentagonal color reproduction range) indicated by dotted lines in FIG. 4.

### (Operation and Effect)

In the first embodiment, the separation optical element (the prism 220 and the prism 230) separates the main component light with the predetermined wavelength of the emission light (the green component light G) into the first optical path, and separates the remaining component light, other than the main component light, of the emission light (the green component light G) into the second optical path. That is, only the main component light of the emission light is guided to the first imager (the DMD 40G). Meanwhile, in addition to the predetermined color component light emitted from the solid light source (the light source 10R and the light source 10B₂), the remaining component light, other than the main component light, of the emission light, is guided to the second imager (the DMD 40R and the DMD 40B).

In this way, since a wavelength range of the emission light (the green component light G) guided to the first imager (the DMD 40G) is narrow, even in the case of using the light emitting body, it is possible to expand the color reproduction range. Furthermore, in general, since the color purity of the predetermined color component light emitted from the solid light source (the light source 10R and the light source 10B₂) is significantly high, and the emission light (the remaining component light other than the main component light) is guided to the second imager (the DMD 40R and the DMD 40B) in addition to the predetermined color component light, the color reproduction range is an appropriate range.

### [First Modification]

Hereafter, a first modification of the first embodiment is explained. Mainly the differences from the first embodiment are described, below.

Specifically, in the first embodiment, the case in which the emission light is only the green component light G has been described as an example. However, in the first modification, the case in which the emission light is the green component light G and the red component light R is described as an example.

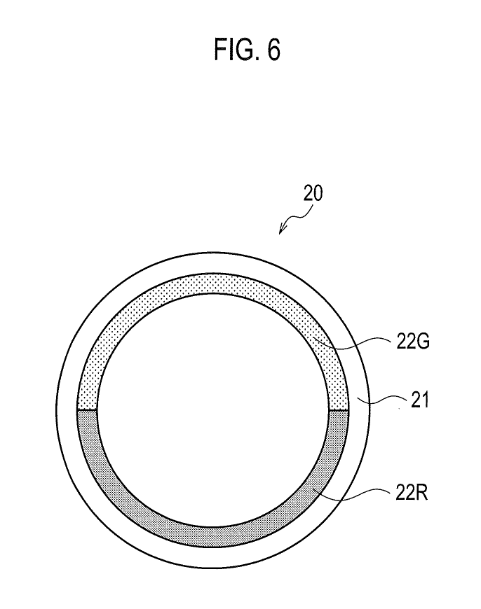

In the first modification, as illustrated in FIG. 6, the color wheel 20 has a red region 22R in addition to the green region 22G. The red region 22R has a light emitting body R that emits the red component light R (the emission light) in response to the excitation light (the blue component light B) emitted from the light source 10B₁. The light emitting body R is a fluorescent substance or a phosphorescent body.

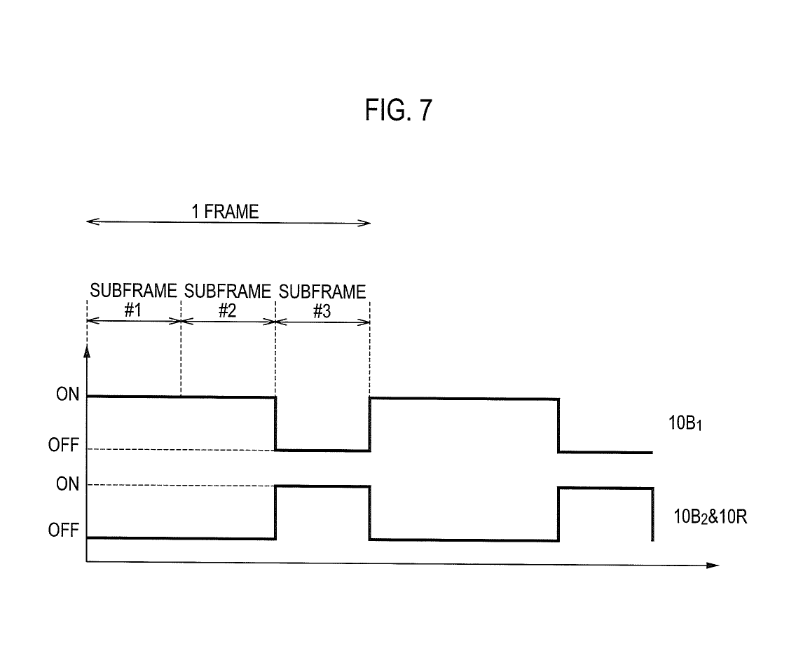

As illustrated in FIG. 7, one frame, for example, includes three subframes. A subframe #1 and a subframe #2 are light emitting periods (ON) of the light source 10B₁, and a subframe #3 is a light emitting period (ON) of the light source 10B₂ and the light source 10R. That is, the light emitting period (ON) of the light source 10B₁ is different from the light emitting period (ON) of the light source 10B₂ and the light source 10R.

In addition, in one of the subframe #1 and the subframe #2, the main component light of the emission light (the green component light G) is guided to the DMD 40G, and the remaining component light of the emission light is guided to the DMD 40R and the DMD 40B. In the other of the subframe #1 and the subframe #2, the main component light of the emission light (the red component light R) is guided to the DMD 40R, and the remaining component light of the emission light is guided to the DMD 40G.

That is, the DMD 40R modulates the remaining component light (the light emitting body R component) of the green component light G (the emission light) in the subframe #1, modulates the main component light of the red component light R (the emission light) in the subframe #2, and modulates the red component light R emitted from the light source 10R in the subframe #3.

The DMD 40B modulates the remaining component light (the light emitting body B component) of the green component light G (the emission light) in the subframe #1, and modulates the blue component light B in the subframe #3.

Meanwhile, the DMD 40G modulates the main component light of the green component light G (the emission light) in the subframe #1, and modulates the remaining component light of the red component light R (the emission light) in the subframe #2.

### Other Embodiments

The present invention is explained through the above embodiment, but it must not be understood that this invention is limited by the statements and the drawings constituting a part of this disclosure. From this disclosure, various alternative embodiments, examples, and operational technologies will become apparent to those skilled in the art.

In the embodiments, the DMD 40 is used as the imager. However, the embodiment is not limited thereto. The imager may be three liquid crystal panels (a red liquid crystal panel, a green liquid crystal panel, and a blue liquid crystal panel). The liquid crystal panel may be a transmissive liquid crystal panel or a reflective liquid crystal panel.

In the embodiments, the case in which the blue component light B is used as the excitation light has been described. However, the embodiment is not limited thereto. For example, ultraviolet component light may be used as the excitation light. In such a case, a light emitting body that emits the blue component light B in response to the ultraviolet component light is used.

In the embodiments, the emission light is the green component light G. However, the emission light may be other color component light beams other than the green component light G.

In the embodiments, the predetermined color component light is the blue component light B and the red component light R. However, the predetermined color component light may be any one of the blue component light B and the red component light R. Furthermore, the predetermined color component light may be other color component light beams other than the blue component light B and the red component light R.

What is claimed is:

1. A projection display apparatus comprising a light source unit including an excitation light source that emits excitation light, a rotating body of disk-shaped that rotates about a rotating shaft, a plurality of imagers that modulates a light emitted from the light source unit, and a projection unit that projects light modulated by the plurality of imagers, wherein
the rotating body includes a rotating surface provided with a light emitting body that emits emission light in response to the excitation light,
the light source unit includes a solid light source that emits predetermined color component light, in addition to the excitation light source,
the plurality of imagers include a first imager that modulates the emission light and a second imager that modulates the predetermined color component light,
a first optical path from the light source unit to the first imager and a second optical path from the light source unit to the second imager have a common optical path common to the first optical path and the second optical path,
a separation optical element, that separates the predetermined color component light into the second optical path, is provided on the common optical path, and
the separation optical element separates main component light with a predetermined wavelength, included in the emission light, into the first optical path, and separates remaining component light, other than the main component light, included in the emission light, into the second optical path.

2. The projection display apparatus according to claim 1, wherein
the emission light has green component light as the main component light, and
the predetermined color component light is red component light or blue component light.

3. The projection display apparatus according to claim 1, wherein
the emission light has green component light as the main component light,
the predetermined color component light is red component light or blue component light,
a peak wavelength of the blue component light is in a range of 440 nm to 470 nm,
a peak wavelength of the main component light of the green component light is in a range of 500 nm to 570 nm,
a spectrum width of the main component light of the green component light is 90 nm to 130 nm in full width at half maximum, and
a peak wavelength of the red component light is in a range of 630 nm to 650 nm.

4. The projection display apparatus according to claim 1, wherein
a light emitting period of the excitation light source is different from a light emitting period of the solid light source.
